(19) United States
(12) Patent Application Publication
(10) Pub. No.: US 2026/0229594 A1
(43) Pub. Date: Aug. 6, 2026

(54) LITHIUM AND MANGANESE RICH BATTERY ELECTROLYTES

(71) Applicant: GM Global Technology Operations LLC, Detroit, MI (US)

(72) Inventors: Umamaheswari Viswanathan, Troy, MI (US); Shubha Nageswaran, Sterling Heights, MI (US); Karthikeyan Kaliyappan, LaSalle (CA); Manuela Ferreira Borras, Dearborn, MI (US); Xi Chen, Rochester Hills, MI (US)

(21) Appl. No.: 19/045,114

(22) Filed: Feb. 4, 2025

(51) Int. Cl. H01M 10/0567; B60L 50/64; H01M 10/0569

(52) U.S. Cl. CPC H01M 10/0567; H01M 10/0569; B60L 50/64; H01M 2220/20; H01M 2300/004

(57) ABSTRACT

An electrolyte for a battery cell, a battery cell for a vehicle, and a method of forming an electrolyte. The electrolyte includes a base electrolyte. The base electrolyte includes a primary lithium salt, a carbonate solvent, and an organic sulfate additive. The electrolyte also includes lithium bis(fluorosulfonyl)imide (LiFSI) present in the range of 0.1 percent by weight to 1 percent by weight of the total weight of the electrolyte, a phosphite ester oxygen scavenger present in the range of 0.01 percent by weight to 1.5 percent by weight of the total weight of the electrolyte, and fluoroethylene carbonate present in the range of 0.5 percent by weight to 2.0 percent by weight of the total weight of the electrolyte. The base electrolyte is the remaining weight percent of the total weight percent of the electrolyte, and the total weight percent of the electrolyte is 100 percent by weight.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel.

Battery performance may be quantified by a number of properties including energy density, power density, specific energy, specific power, charge rate, discharge rate, capacity decay, cycle life, thermal performance, and aging. Of particular interest is high voltage performance, about 4.4 volts per cell or higher, and stability in high temperature battery cycling, with temperatures of 45° C. or greater. Conventional lithium ion battery electrolytes at high temperatures may exhibit relatively low high voltage protection. Lithium- and manganese-rich (LMR) battery electrolytes contain relatively high levels of fluorinated solvents increasing their stability at high voltages. However, these electrolytes release gasses, such as oxygen, carbon monoxide, carbon dioxide and hydrogen, at high temperatures, due to decomposition of electrolyte caused by chemical reactions between the components in the electrolyte and other components in the battery cell. The gas is constrained in the battery cells and causes battery cell expansion.

In addition, during formation of lithium- and manganese-rich batteries, it is desirable to convert manganese from a layered structure to a spinel structure. Conversion of the manganese to the spinel structures increases specific capacity. If formation occurs around room temperature, then manganese conversion continues to occur during further charge and discharge cycles, complicating programming the battery management system and creating other issues. Formation at higher temperatures, such as around 45 degrees Celsius, increases manganese conversion to spinel structures, but, again, causes gassing of the electrolyte.

Thus, while present electrolyte chemistries and other battery materials achieve their intended purpose, there is a need for new and improved electrolyte chemistries that offer relatively improved high temperature performance.

### SUMMARY

According to various aspects, the present disclosure relates to an electrolyte for a battery cell. The electrolyte includes a base electrolyte. The base electrolyte includes a primary lithium salt, a carbonate solvent, and an organic sulfate additive. The electrolyte also includes lithium bis(fluorosulfonyl)imide (LiFSI) present in the range of 0.1 percent by weight to 1 percent by weight of the total weight of the electrolyte, a phosphite ester oxygen scavenger present in the range of 0.01 percent by weight to 1.5 percent by weight of the total weight of the electrolyte, and fluoroethylene carbonate present in the range of 0.5 percent by weight to 2.0 percent by weight of the total weight of the electrolyte. The base electrolyte is the remaining weight percent of the total weight percent of the electrolyte, and the total weight percent of the electrolyte is 100 percent by weight.

In embodiments, the primary lithium salt includes lithium hexafluorophosphate present at a concentration in the range of 0.6 moles of salt per liter (M) to 2.0 M in the carbonate solvent, and the lithium bis(fluorosulfonyl)imide is present at a concentration in the range of 0.01 moles of salt per liter (M) to 0.2 M in the carbonate solvent.

In any of the above embodiments, the carbonate solvent includes ethylene carbonate, ethyl methyl carbonate, and diethyl carbonate. In further embodiments, the ethylene carbonate is present in the range of 20 percent by volume to 30 percent by volume of the total volume of the carbonate solvent, the ethyl methyl carbonate is present in the range of 60 percent by volume to 70 percent by volume of the total volume of the carbonate solvent, and the diethyl carbonate is present in the range of 5 to 10 percent by volume of the total volume of the carbonate solvent, wherein the total volume percent of the carbonate solvent is 100 percent.

In any of the above embodiments, the organic sulfate additive includes methylene methanedisulfonate and is present in the electrolyte in the range of 0.5 percent by weight to 1 percent by weight of the total weight of the electrolyte.

In any of the above embodiments, the phosphite ester oxygen scavenger is tris(1,1,1,3,3,3-hexafluoro-2-propyl) phosphite (THFPPi).

In embodiments, the base electrolyte includes lithium hexafluorophosphate (LiPF₆) present in the carbonate solvent at a concentration of 1.1 M, ethylene carbonate (EC) present at 25 percent by volume of the total volume of the carbonate solvent, ethyl methyl carbonate (EMC) present at 65 percent by volume of the total volume of the carbonate solvent, diethyl carbonate (DEC) present at 10 percent by volume of the total volume of the carbonate solvent, and the organic sulfate additive is methylene methanedisulfonate present at 1 percent by weight of the total weight of the electrolyte and wherein the lithium bis(fluorosulfonyl)imide (LiFSI) is present at 0.1 percent by weight of the total weight of the electrolyte, the phosphite ester oxygen scavenger is tris(1,1,1,3,3,3-hexafluoro-2-propyl) phosphite present at 0.05 precent by weight of the total weight of the electrolyte, and fluoroethylene carbonate (FEC) is present at 1 percent by weight of the total weight of the electrolyte.

According to various additional aspects, the present disclosure relates to a battery cell for a vehicle. The battery cell includes a cathode electrode including a cathode disposed on a cathode current collector, an anode electrode including an anode disposed on an anode current collector, a separator positioned between the cathode and the anode, and an electrolyte contacting the cathode, anode, and separator. The electrolyte includes a base electrolyte. The base electrolyte includes a primary lithium salt, a carbonate solvent, and an organic sulfate additive. The electrolyte also includes lithium bis(fluorosulfonyl)imide (LiFSI) present in an amount in the range of 0.1 percent by weight to 1 percent by weight of the total weight of the electrolyte, a phosphite ester oxygen scavenger present in the range of 0.01 percent by weight to 1.5 percent by weight of the total weight of the electrolyte, and fluoroethylene carbonate present in the range of 0.5 percent by weight to 2.0 percent by weight of the total weight of the electrolyte. The base electrolyte is the remaining weight percent of the total weight percent of the electrolyte, and the total weight percent of the electrolyte is 100 percent by weight. In embodiments, the electrolyte is according to any of the embodiments described above.

In embodiments of the above, the primary lithium salt includes lithium hexafluorophosphate present at a concentration in the range of 0.6 moles of salt per liter (M) to 2.0 M in the carbonate solvent, and the lithium bis(fluorosulfonyl)imide is present at a concentration in the range of 0.01 moles of salt per liter (M) to 0.2 M in the carbonate solvent. In further embodiments, the carbonate solvent includes ethylene carbonate, ethyl methyl carbonate, and diethyl carbonate. In yet further embodiments, the ethylene carbonate is present in the range of 20 percent by volume to 30 percent by volume of the total volume of the carbonate solvent, the ethyl methyl carbonate is present in the range of 60 percent by volume to 70 percent by volume of the total volume of the carbonate solvent, and the diethyl carbonate is present in the range of 5 to 15 percent by volume of the total volume of the carbonate solvent, wherein the total volume percent of the carbonate solvent is 100 percent.

In any of the above embodiments, the organic sulfate additive is methylene methanedisulfonate, wherein the methylene methanedisulfonate is present in the electrolyte in the range of 0.5 percent by weight to 1 percent by weight of the total weight of the electrolyte.

In any of the above embodiments, the primary lithium salt includes lithium hexafluorophosphate present at a concentration in the range of 0.6 M to 2.0 M in the carbonate solvent, the carbonate solvent includes ethylene carbonate present in the range of 20 percent by volume to 30 percent by volume of the total volume of the carbonate solvent, ethyl methyl carbonate present in the range of 60 percent by volume to 70 percent by volume of the total volume of the carbonate solvent, and diethyl carbonate present in the range of 5 to 10 percent by volume of the total volume of the carbonate solvent, wherein the total volume percent of the carbonate solvent is 100 percent, and the organic sulfate additive is methylene methanedisulfonate present in the electrolyte in the range of 0.5 percent by weight to 1 percent by weight of the total weight of the electrolyte.

In any of the above embodiments, the phosphite ester oxygen scavenger is tris(1,1,1,3,3,3-hexafluoro-2-propyl) phosphite (THFPPi).

In any of the above embodiments, the cathode exhibits the following composition: xLi₂MnO₃-(1-x)LiMO₂, where “M” is at least one of nickel, cobalt, and manganese, and “x” is in the range of 0 to 1.

In any of the above embodiments, the cathode is selected from at least one of lithium nickel manganese oxides, lithium nickel manganese cobalt oxides, lithium nickel cobalt aluminum oxides, and lithium nickel cobalt manganese aluminum oxide.

In any of the above embodiments, the anode includes at least one of graphite and graphite-silicon, wherein silicon is present in the range of 0.1 percent by weight to 30 percent by weight of the total weight of the graphite-silicon.

According to various further aspects, the present disclosure relates to a method of forming an electrolyte. The method includes mixing a base electrolyte, wherein the base electrolyte includes a primary lithium salt, a carbonate solvent, and an organic sulfate additive, with lithium bis(fluorosulfonyl)imide (LiFSI) present in an amount in the range of 0.1 percent by weight to 1 percent by weight of the total weight of the electrolyte, a phosphite ester oxygen scavenger present in the range of 0.01 percent by weight to 1.5 percent by weight of the total weight of the electrolyte, and fluoroethylene carbonate present in the range of 0.5 percent by weight to 2.0 percent by weight of the total weight of the electrolyte, wherein the base electrolyte is the remaining weight percent of the total weight percent of the electrolyte and the total weight percent of the electrolyte is 100 percent by weight.

In embodiments of the above, the method further includes forming the base electrolyte by mixing the primary lithium salt, the carbonate solvent, and the methylene methanedisulfonate, wherein the primary lithium salt includes lithium hexafluorophosphate present at a concentration in the range of 0.6 M to 2.0 M in the carbonate solvent, the carbonate solvent includes ethylene carbonate present in the range of 20 percent by volume to 30 percent by volume of the total volume of the carbonate solvent, ethyl methyl carbonate present in the range of 60 percent by volume to 70 percent by volume of the total volume of the carbonate solvent, and diethyl carbonate present in the range of 5 to 10 percent by volume of the total volume of the carbonate solvent, wherein the total volume percent of the carbonate solvent is 100 percent, and the organic sulfate additive is methylene methanedisulfonate present in the electrolyte in the range of 0.5 percent by weight to 1 percent by weight of the total weight of the electrolyte.

In any of the above embodiments, the method further includes introducing the electrolyte into a battery cell, charging and discharging the battery cell at temperatures in the range of 45 degrees Celsius to 80 degrees Celsius, and forming a solid-electrolyte interface.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates an exploded view of the layers of a battery cell according to embodiments of the present disclosure.

FIG. 2B illustrates a pouch or prismatic battery cell according to embodiments of the present disclosure.

FIG. 2C illustrates a cylindrical battery cell according to embodiments of the present disclosure.

FIG. 2D illustrates a coin battery cell according to embodiments of the present disclosure.

FIG. 3 illustrates a method of forming an electrolyte and a battery cell according to embodiments of the present disclosure.

FIG. 4 illustrates a graph of the specific capacity of battery cells (y-axis) including various additive formulations in the electrolyte relative to charge-discharge cycle number (x-axis).

FIG. 5 illustrates a graph of the change in thickness of battery pouch cells (y-axis) including various electrolyte formulations (x-axis).

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to an electrolyte, a battery cell for a vehicle including the electrolyte, and a method of forming the electrolyte. The electrolyte can be used in a number of battery cell platforms including prismatic, pouch, cylindrical, or coin style battery cells. The electrolyte and battery cell can be used in batteries for electric or hybrid-electric vehicles. The electrolyte includes fluoroethylene carbonate present at 2 percent by weight or less of the total weight of the electrolyte and provides stability at voltages of 4.0 Volts (V) or greater, such as in the range of 4.0 volts to 4.5 volts. In embodiments, the electrolyte also includes 10 percent by volume or less of diethyl carbonate in the carbonate solvent. In further embodiments, the battery cell exhibits increased temperature cycling stability at temperatures of 45 degrees Celsius or greater, such as in the range of 45 degrees Celsius to 80 degrees Celsius.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

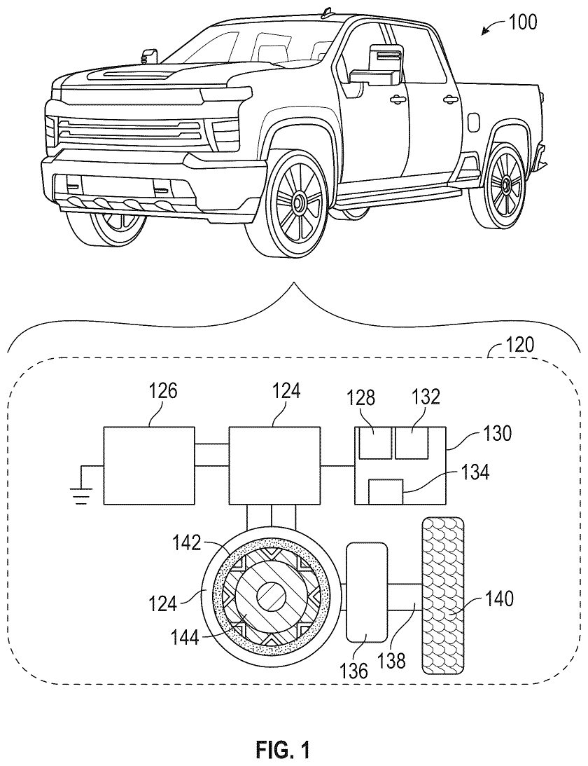

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124, powered by the battery 126, includes a stator 142 and a rotor 144 arranged within the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotating field (as caused by physical rotation) of the rotor 144 generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

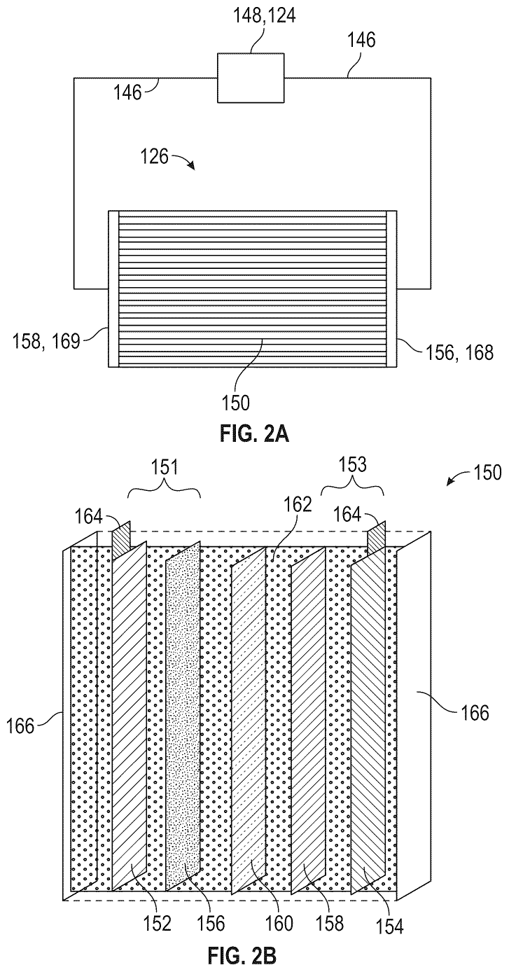

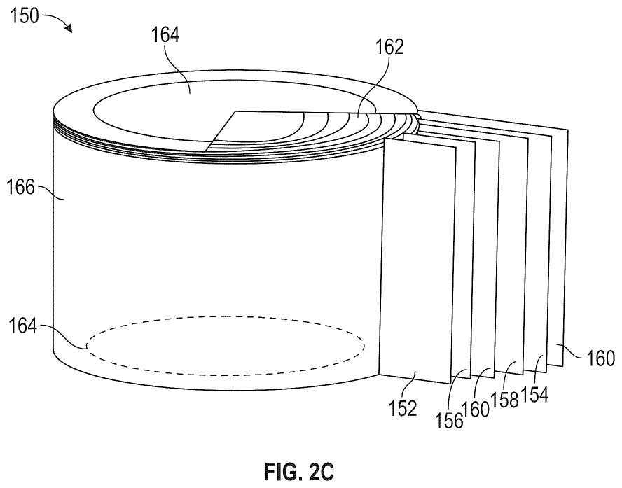

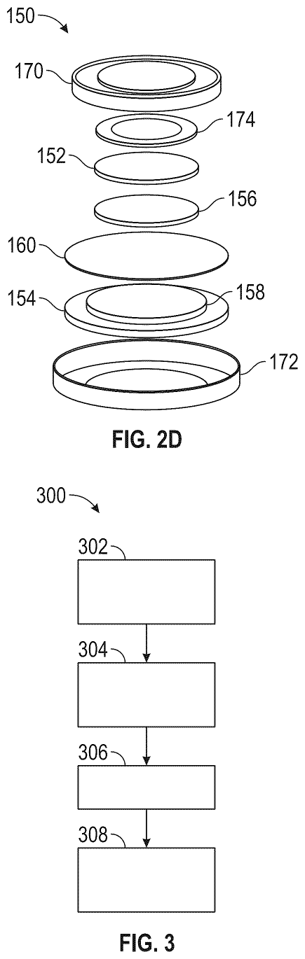

Reference is made to FIGS. 2A, 2B, 2C, and 2D illustrating an example of a secondary battery 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. Referring to FIGS. 2A, 2B, 2C, and 2D, a battery 126 is illustrated as being connected to a load 148, such as the electric motor 124. However, other loads 148 include various systems in the vehicle 100 such as climate control systems and infotainment systems. The battery 126 includes one or more battery cells 150, that are assembled together. The battery cells 150 may be, for example, pouch style, prismatic, cylindrical, or coin style battery cells, which are discussed further below. With reference to FIGS. 2B through 2D, when a load 148 is applied to the battery 126, Li+ ions move from the anode 158 to the cathode 156 through the separator 160 by way of the electrolyte 162. Equivalent electrons e-move through the circuitry 146 from the cathode 156 to the anode 158, providing voltage to the load 148. While charging, upon application of an external voltage, Li+ ions move from the cathode 156 to the anode 158 by way of the electrolyte 162 through the separator 160 and may be intercalated into the anode 158.

Each battery cell 150, such as those illustrated in FIGS. 2B, 2C, and 2D, generally includes a cathode current collector 152, a cathode 156 disposed on the cathode current collector 152, an anode current collector 154, an anode 158 disposed on the anode current collector 154, a separator 160 positioned between the cathode 156 and anode 158, and an electrolyte 162. While the illustrated battery cells 150 include one anode 158 (and anode current collector 154) and one cathode 156 (and one cathode current collector 152), the battery cell 150 may alternatively include two or more cathodes 156 (and one or more cathode current collectors 152) and one or more anodes 158 (and one or more anode current collectors 154). In further alternative embodiments, the battery cell 150 may include or one or more cathodes 156 (and one or more cathode current collectors 152) and two or more anodes 158 (and two or more anode current collectors 154). In any of the designs above, one or more separators 160 are interleaved between the cathodes 156 and anodes 158 to prevent the cathodes 156 and the anodes 158 from contacting.

In embodiments, the battery cell 150 of FIG. 2B is configured as a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154. Alternatively, the tabs 164 are formed integrally with the cathode current collectors 152 and anode current collectors 154 by cutting the tabs 164 with the cathode current collectors 152 and anode current collectors 154 from larger sheet stock. In addition, the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

Alternatively, the battery cell 150 of FIG. 2C is configured as a cylinder style battery cell 150. In this design, the cathode current collector 152, anode current collector 154, cathode 156, anode 158, and one or more separators 160 are in the form of long ribbons, which are rolled into a cylinder or jelly roll. Like the prismatic cell, the covering 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In alternative embodiments, the battery cell 150 is packaged in a coin cell as illustrated in FIG. 2D. In this design, the cathode current collector 152, anode current collector 154, cathode 156, anode 158, and one or more separators 160 are in the form of discs, which are sandwiched together in the coin packaging forming the covering 166, which includes a cap 170 and a can 172. A spring washer 174 may be included between the cathode current collector 152 and the cap 170. Prior to securing the cap 170 on the can 172, electrolyte 162 is added to the battery cell 150. The cap includes terminals 164 for the anode 158 and cathode 156.

In the various styles of battery cells 150 noted above, the cathode current collector 152 and anode current collector 154 are formed from conductive materials. In embodiments, the cathode current collector 152 includes aluminum. Alternatively, or additionally, the cathode current collector 152 may include one of carbon coated aluminum and stainless steel. In embodiments, the anode current collector 154 includes copper. Alternatively or additionally, the anode current collector 154 may include nickel, stainless steel, and titanium. The current collectors 152, 154 are illustrated as being in the form of a foil; however, it should be appreciated that other forms may be exhibited such as mesh. In embodiments, a foil cathode current collector 152 and a foil anode current collector 154 are impermeable to gas. The cathode current collector 152 exhibits a thickness in the range of 5 micrometers to 50 micrometers, including all values and ranges therein, such as in the range of 5 micrometers to 25 micrometers. The anode current collector 154 exhibits a thickness in the range of 4 micrometers to 50 micrometers, including all values and ranges therein, such as in the range of 4 micrometers to 25 micrometers.

The cathode 156 includes a source of lithium ions (Li⁺) and can undergo reversible insertion or intercalation of lithium ions, determining e.g., the capacity and average voltage of a battery. In embodiments, the cathode material includes lithium- and manganese-rich material having the formulation xLi₂MnO₃-(1-x)LiMO₂, where “M” is at least one of nickel, cobalt, and manganese, and “x” is a fraction indicating the relative proportion of the Li₂MnO₃ phase within the structure and is in the range of 0 to 1. Additional or alternatively, the cathode material includes lithium nickel manganese oxides, lithium nickel manganese cobalt oxides, lithium nickel cobalt aluminum oxides, and lithium nickel cobalt manganese aluminum oxide. In embodiments, the lithium nickel manganese cobalt oxides having the formula LiNiₐMn_{b}Co_{c}O₂, wherein the sum of a, b, and c is 1 such as a LiNi_{0.33}Mn_{0.33}Co_{0.33}O₂(NMC111), LiNi_{0.5}Mn_{0.3}Co_{0.2}O₂(NMC 523), LiNi_{0.6}Mn_{0.2}Co_{0.2}O₂ (NMC 622), LiNi_{0.7}Mn_{0.2}Co_{0.1}O₂(NMC 721), LiNi_{0.75}Mn_{0.25}O₂(NM75), and LiNi_{0.8}Mn_{0.1}Co_{0.1}O₂(NMC 811). In further embodiments, the lithium manganese oxide cathode, Li₂Mn₂O₄, is a spinel type cathode.

In embodiments, the cathode material is deposited on the cathode current collector 152 at a density in the range of 1.5 milliamp-hours per square centimeter to 5 milliamp-hours per square centimeter, including all values and ranges therein, such as from 1.7 milliamp-hours per square centimeter to 3.5 milliamp-hours per square centimeter. The cathode material includes particles that exhibit a particle size (largest linear cross-section as measured by optical microscopy) of in the range of 5 nanometers to 50 micrometers including all values and ranges therein.

The cathode electrode 151, including both the cathode current collector 152 and the cathode 156, exhibits a thickness in the range of 10 micrometers to 500 micrometers including all values and ranges therein when the cathode material is formed on one side of the cathode current collector 152. When the cathode material is formed on both sides of the cathode current collector 152, the cathode electrode exhibits a thickness in the range of 30 micrometers to 1050 micrometers including all values and ranges therein for a double sided cathode electrode, such as in the range of 205 micrometers to 500 micrometers.

The anode 158 includes materials that can undergo reversible insertion or intercalation of lithium ions at a lower electrochemical potential than the cathode 156 material, such that an electrochemical potential difference exists between the anode 158 and cathode 156. In embodiments, the anode material includes graphite optionally in combination with a silicon compound. In embodiments, the graphite includes at least one of pure graphite and a surface modified artificial graphite. In further embodiments, the graphite is modified with at least one of hard carbon (also referred to as non-graphitizing carbon or char) and soft carbon (also referred to as graphitizing carbon). In further embodiments, the graphite exhibits an average particle size of D50 between 6 micrometers and 20 micrometers. In addition, the graphite exhibits a surface area of 1 square meter per gram to 120 square meters per gram as measured by Brunauer-Emmett-Teller (BET) surface area analysis. The graphite exhibits a Gra weight percent in the range of 50 weight percent to 100 weight percent. Further the tap density of the graphite is in the range of 0.5 grams per cubic centimeters to 1.5 grams per cubic centimeters including all values and ranges therein.

In further embodiments, the anode material includes graphite present in the range of 70 percent by weight to 99.9 percent by weight of the total weight of the anode, including all values and ranges therein, and a silicon compound present in the range of 0.1 percent by weight to 30 percent by weight of the total weight of the anode, including all values and ranges therein such as 0.1 percent by weight to 30 percent by weight, wherein the total percent by weight of the anode is 100 percent. In further embodiments, the anode material includes graphite present in the range of 80 percent by weight to 95 percent by weight of the total weight of the anode, including all values and ranges therein, and the silicon compound present in the range of 5 percent by weight to 20 percent by weight of the total weight of the anode, including all values and ranges therein, wherein the total weight percent of the anode is 100 percent. The silicon compound includes at least one of silicon, silicon oxide (SiOx, wherein x is in the range of 1 to 2), lithiated silicon oxide (LSO), silicon carbon (SiC), and a silicon alloy such as silicon-titanium (SiTi), silicon niobium (Si—Nb), and silicon-aluminum (Si—Al). Lithiated silicon oxide exhibits the formula Li_{y}SiOₓ, wherein x is between 0 and 2 and y is between 0 and 1. The average particle size of the lithiated silicon oxide is 3 micrometers<D50<20 micrometers. The lithiated silicon oxide also exhibits a surface area of 0.5 square meter per gram to 10 square meters per gram as measured by Brunauer-Emmett-Teller (BET) surface area analysis. Further the tap density of the lithiated silicon oxide is in the range of 0.8 grams per cubic centimeters to 1.5 grams per cubic centimeters including all values and ranges therein. The silicon content in the silicon carbide is in the range of 30 percent by weight to 60 percent by weight of the silicon carbide, including all values and ranges therein. The average particle size of the silicon carbide is 3 micrometers<D50<20 micrometers. The silicon carbide also exhibits a surface area of 0.5 square meter per gram to 10 square meters per gram as measured by Brunauer-Emmett-Teller (BET) surface area analysis. Further the TD density of the silicon carbide is in the range of 0.6 grams per cubic centimeters to 1.5 grams per cubic centimeters including all values and ranges therein. Additionally, or alternatively, the anode material includes one or more tin oxide; aluminum; indium; zinc; germanium; and titanium oxide, as well as any combination of the above.

In embodiments, the anode material is deposited on the anode current collector 154 at a density in the range of 1.65 milliamp-hours per square centimeter to 5.5 milliamp-hours per square centimeter, including all values and ranges therein such as from 1.87 milliamp-hours per square centimeter to 3.85 milliamp-hours per square centimeter. Further, the press density, density after pressing, of the anode material is in the range of 1.3 grams per cubic centimeter to 2 grams per cubic centimeter, including all values and ranges therein, such as from 1.5 grams per cubic centimeter to 1.7 grams per cubic centimeter.

In embodiments, the anode 158 exhibits a thickness in the range of 10 micrometers to 550 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shorting out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include one or more fillers dispersed therein, wherein the one or more fillers includes materials such as glass fiber, nonwoven fabrics, or woven fabrics. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of a film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions travel. The electrolyte 162 is a liquid electrolyte that permeates the separator 160, contacts the surfaces of the cathode 156 and anode 158, and flows into interstices that may be present between the particles forming the cathode 156 and the anode 158. The electrolyte 162 generally includes a base electrolyte and an additive formulation.

The base electrolyte includes a primary lithium salt, a carbonate solvent, and an organic sulfate additive. The primary lithium salt includes lithium hexafluorophosphate (LiPF₆). Additionally, or alternatively, the primary lithium salt may include one or more of lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium hexafluoroarsenate (LiAsF₆), lithium trifluoromethanesulfonate (LiCF₃SO₃), lithium bis(trifluoromethane)sulfonylimide (LiN(CF₃SO₂)₂), and lithium bis(trifluoromethanesulfonyl)azanide (LiTFSA). In embodiments, the primary lithium salt is present in the solvent at a concentration (moles (mol) of salt per liter (L) of solvent) of 0.6 mol/L (M) to 2.0 M, including all values and ranges therein, such as 1.1 M. The carbonate solvent includes a cyclic carbonate and at least two linear carbonates. The cyclic carbonate includes ethylene carbonate (EC). The cyclic carbonate is present in the range of 20 percent by volume to 30 percent by volume of the total volume of solvent, including all values and ranges therein, such as 25 percent by volume. The linear carbonates include ethyl methyl carbonate (EMC) and diethyl carbonate (DEC). DEC is understood to increase stability at temperatures of 45 degrees or higher. The linear carbonate is present in the range of 60 percent by volume to 80 percent by volume of the total volume of carbonate solvent, including all values and ranges therein, such as 70 percent by volume. In embodiments, the ethyl methyl carbonate is present in the range of 60 percent by volume to 70 percent by volume of the total volume of the carbonate solvent, including all values and ranges therein such as 65 percent by volume, and the diethyl carbonate is present in the range of 5 to 10 percent by volume of the total volume of the carbonate solvent, including all values and ranges therein such as 10 percent by volume. The use of the linear carbonates is believed to reduce the viscosity of the solvent and improve battery cell charge rate capability. The total volume percent of the carbonate solvent is 100 percent. The organic sulfate additive includes heterocyclic compounds including at least one sulfur and at least one oxygen in the ring, the ring being a 5 member or six member ring. In addition, at least one sulfur, if more than one are present, forms a part of a sulfonyl group. In embodiments, the organic sulfate additive includes methylene methanedisulfonate (MMDS). Alternatively, or additionally, the organic sulfate additive includes at least one of 1,3-propane sultone, prop-1-ene-1,3-sultone, and 1,3,2-dioxathiolane-2,2-dioxide. The organic sulfate additive is present at levels in the range of 0.1 percent by weight to 2.0 percent by weight of the total weight of the electrolyte, including all values and ranges therein. Methylene methanedisulfonate is understood to reduce solvent decomposition during cycling, reducing gassing.

The additive formulation includes lithium bis(fluorosulfonyl)imide (LiFSI), a phosphite ester oxygen scavenger, and fluoroethylene carbonate. The lithium bis(fluorosulfonyl)imide (LiFSI) is present in the electrolyte in an amount of 0.1 percent by weight to 1 percent by weight of the total weight of the electrolyte 162, including all values and ranges therein. The concentration of the lithium bis(fluorosulfonyl)imide (LiFSI) in the carbonate solvent is 0.01 to 0.2 M, including all values and ranges therein, such as 0.1 M. The total concentration of the primary lithium salt and secondary lithium salt, if present, is up to 2.0 M, including all values and ranges from 0.6 M to 2.0 M, such as 1.2 M. The combination of the lithium hexafluorophosphate (LiPF₆) and lithium bis(fluorosulfonyl)imide (LiFSI) are understood to enhance lithium ion conductivity and the LiFSI is understood to increase thermal stability. The phosphite ester oxygen scavenger includes tris(1,1,1,3,3,3-hexafluoro-2-propyl) phosphite (THFPPi) present in the range of 0.01 percent by weight to 1.5 percent by weight of the total weight of the electrolyte. The THFPPi is understood to increase electrolyte stability at voltages of 4.0 volts or greater and also to form a relatively thin and stable cathode-electrolyte interface, wherein stability is measured by cyclic voltammogram of the electrolyte. In addition the phosphorous in the phosphite is understood to capture oxygen released by the cathode. Additionally or alternatively to the THFPPi, the oxygen scavenger includes tris(trimethylsilyl) phosphite. The additive formulation also includes fluoroethylene carbonate (FEC) present in the range of 0.1 percent by weight to 2.0 percent by weight of the total weight of the electrolyte, including all values and ranges therein such as 1.0 percent by weight. The FEC is understood to increase voltage stability at voltages of 4.0 volts or greater and protect the anode. It should be appreciated that the total weight percent of the electrolyte including the base electrolyte, lithium bis(fluorosulfonyl)imide, tris(1,1,1,3,3,3-hexafluoro-2-propyl) phosphite, and fluoroethylene carbonate, is 100 percent by weight.

In examples, the electrolyte 162 includes a base electrolyte of 1.1 M lithium hexafluorophosphate (LiPF₆) in a carbonate solvent of ethylene carbonate (EC) present at 25 percent by volume of the total volume of the solvent, ethyl methyl carbonate (EMC) present at 65 percent by volume of the total volume of the solvent, diethyl carbonate (DEC) present at 10 percent by volume of the total volume of the solvent, and methylene methanedisulfonate present at 1 percent by weight of the total weight of the electrolyte. In one example, the base electrolyte is combined with an additive formulation of lithium bis(fluorosulfonyl)imide (LiFSI) present at 0.1 percent by weight of the total weight of the electrolyte, tris(1,1,1,3,3,3-hexafluoro-2-propyl) phosphite present at 0.05 percent by weight of the total weight of the electrolyte, and fluoroethylene carbonate (FEC) present at 1 percent by weight of the total weight of the electrolyte. In another example, the base electrolyte is combined with an additive formulation of lithium bis(fluorosulfonyl)imide (LiFSI) present at 0.1 percent by weight of the total weight of the electrolyte, tris(1,1,1,3,3,3-hexafluoro-2-propyl) phosphite present at 1 percent by weight of the total weight of the electrolyte, and fluoroethylene carbonate (FEC) present at 1 percent by weight of the total weight of the electrolyte. In a further example, the base electrolyte is combined with an additive formulation of lithium bis(fluorosulfonyl)imide (LiFSI) present at 0.1 percent by weight of the total weight of the electrolyte, tris(1,1,1,3,3,3-hexafluoro-2-propyl) phosphite present at 0.05 precent by weight of the total weight of the electrolyte, and fluoroethylene carbonate (FEC) present at 1 percent by weight of the total weight of the electrolyte. In yet another example, the base electrolyte is combined with an additive formulation of lithium bis(fluorosulfonyl)imide (LiFSI) present at 1 percent by weight of the total weight of the electrolyte, tris(1,1,1,3,3,3-hexafluoro-2-propyl) phosphite present at 1 precent by weight of the total weight of the electrolyte, and fluoroethylene carbonate (FEC) present at 1 percent by weight of the total weight of the electrolyte.

The electrolyte 162 is formed by mixing the carbonate solvent, the primary lithium salt, the organic sulfate additive, the lithium bis(fluorosulfonyl)imide, the phosphite ester oxygen scavenger, and the fluoroethylene carbonate. In embodiments, the base electrolyte (including the carbonate solvent, the primary lithium salt, and the organic sulfate ester) and the additive formulation (including the lithium bis(fluorosulfonyl)imide, phosphite ester oxygen scavenger, and the fluoroethylene carbonate) may be separately combined and then the base electrolyte and the additive formulation may be combined together. The electrolyte 162 may then be added to a battery cell, including any one of the battery cells 150 illustrated in FIGS. 2B through 2D. FIG. 3 illustrates an embodiment of a method 300 of forming a battery cell 150 including the electrolyte 162. At block 302, the cathode current collector 152 with the cathode 156, the anode current collector 154 with the anode 158, and the separator 160 are assembled in a battery cell 150 covering 166, 170, 172. In embodiments, the cathode 156 is deposited onto the cathode current collector 152 prior to battery cell 150 assembly and the anode 158 is deposited onto the anode current collector 154 prior to battery cell 150 assembly. At block 304, the electrolyte 162 is added to the battery cell 150. At block 306 the battery cell 150 is sealed. In further embodiments, at block 308 the battery cell 150 is coupled to a circuit and undergoes formation as current is applied to the battery cell 150 for the first time. Subsequent charging and discharging cycles may then be performed up to 2 cycles. Battery formation occurs at temperatures of 45 degrees Celsius or greater, such as in the range of from 45 degrees Celsius to 80 degrees Celsius and at a charge and discharge rate in the range of 3 hours to 10 hours per charge and in the range of 3 hours to 10 hours per discharge, often the charge and discharge rates are the same. Formation at 45 degrees Celsius allows for the battery cell to achieve or come close to achieving maximum capacity during formation and reduces lithium plating on the anode. As noted above, during battery formation, a solid-electrolyte interface forms on the anode including organic solvent reaction products with lithium, a cathode electrolyte interface form on the cathode, structural changes occur to the cathode and anode materials.

### Examples

The following examples are not meant to limit the scope of the disclosure but are provided herein for illustrative purposes.

Coin cells including a base electrolyte and various additive formulations were prepared. The base electrolyte included 1.1 M lithium hexafluorophosphate (LiPF₆) in a carbonate solvent of ethylene carbonate (EC) present at 25 percent by volume of the total volume of the solvent, ethyl methyl carbonate (EMC) present at 65 percent by volume of the total volume of the solvent, diethyl carbonate (DEC) present at 10 percent by volume of the total volume of the solvent, and methylene methanedisulfonate present at 1 percent by weight of the total weight of the electrolyte. The additive formulations, including lithium bis(fluorosulfonyl)imide, tris(1,1,1,3,3,3-hexafluoro-2-propyl)phosphite, and fluoroethylene carbonate, are presented in Table 1 below. All amounts presented in the table are in weight percent (wt. %) of the total weight of the electrolyte.

TABLE 1
Additive formulations

| | | tris(1,1,1,3,3,3- | |
|---|---|---|---|
| | Lithium | hexafluoro-2- | fluoroethylene |
| Formu- | bis(fluorosulfonyl)imide | propyl) phosphite | carbonate |
| lation | (wt. %) | (wt. %) | (wt. %) |
| A | 0.1 | 0.05 | 1 |
| B | 0.1 | 1 | 1 |
| C | 1 | 0.05 | 1 |
| D | 1 | 1 | 1 |

The coin cells each included a graphite anode, a lithium- and manganese-rich anodes having the formulation: 97% active material for the cathode and 95% active material for the anode, a spacer of one millimeters in thickness, a wave spring of 1.4 millimeters in thickness in a case including a stainless steel cap and can.

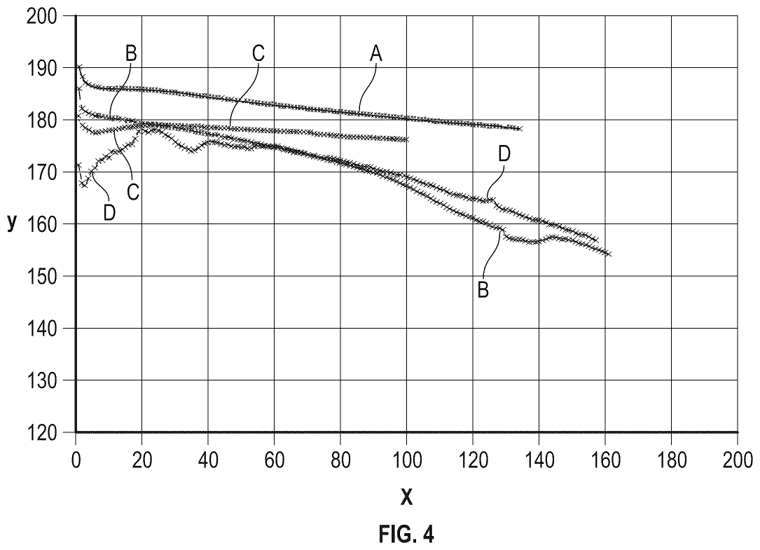

The coin cells underwent formation at 45 degrees Celsius and at least 100 charge and discharge cycles at rate of 3 hours per each charge and 3 hours per each discharge at an applied voltage in the range of 2 volts to 4.4 volts during cycling. The measured specific capacity in milliamp-hours per gram was measured for each charge cycle. FIG. 4 illustrates the retention of specific capacity (y-axis) over the charge cycles (x-axis) for each formulation A through D.

Five pouch style battery cells were prepared and measured for thickness change. Three of the pouch style battery cells included the base electrolyte, each with a different additive formulation, and two of the pouch style battery cells were prepared with different electrolytes. The base electrolyte included 1.1 M lithium hexafluorophosphate (LiPF₆) in a carbonate solvent of ethylene carbonate (EC) present at 25 percent by volume of the total volume of the solvent, ethyl methyl carbonate (EMC) present at 65 percent by volume of the total volume of the solvent, diethyl carbonate (DEC) present at 10 percent by volume of the total volume of the solvent, and methylene methanedisulfonate present at 1 percent by weight of the total weight of the electrolyte. The additive formulations, including lithium bis(fluorosulfonyl)imide, tris(1,1,1,3,3,3-hexafluoro-2-propyl)phosphite, and fluoroethylene carbonate, are presented in Table 2 below. All amounts presented in the table are in weight percent (wt. %) of the total weight of the electrolyte.

TABLE 2
Additive formulations

| | | tris(1,1,1,3,3,3- | |
|---|---|---|---|
| | Lithium | hexafluoro-2- | fluoroethylene |
| Formu- | bis(fluorosulfonyl)imide | propyl) phosphite | carbonate |
| lation | (wt. %) | (wt. %) | (wt. %) |
| A | 0.1 | 0.05 | 1 |
| B | 0.1 | 1 | 1 |
| C | 1 | 0.05 | 1 |

The additional two electrolytes included in the pouch cells included electrolyte E including 20 percent by volume fluoroethylene carbonate and 80 percent by volume diethyl carbonate, and electrolyte F including 30 percent by volume ethyl carbonate, 70 percent by volume dimethyl carbonate, 2 percent by volume fluoroethylene carbonate, and 1 percent by volume vinylene carbonate. Each pouch cell also included a lithium- and manganese-rich cathode including the formulation 97% active material, a graphite anode, a copper cathode current collector, and an aluminum anode current collector. The pouches underwent formation from 2 volts to 4.5 volts at 45 degrees Celsius.

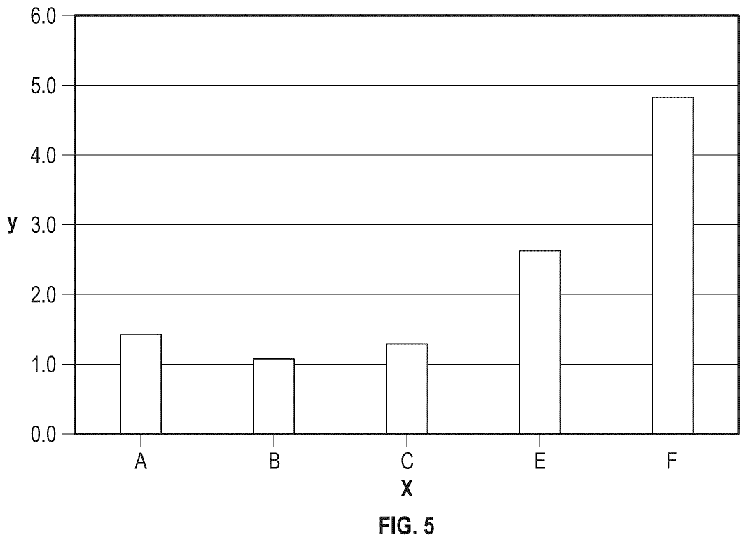

The thickness of the pouch cells were initially measured prior to formation and measured again after formation. The pouch cells underwent formation at 45 degrees Celsius and at least 100 charge and discharge cycles at rate of 3 hours per each charge and 3 hours per each discharge with an applied voltage during cycling in the range of 2 volts to 4.4 volts. FIG. 5 illustrates the increase in thickness (y-axis) for each formulation A through C, E, and F. As illustrated, the pouch cells including the base electrolyte with the additive formulation exhibited a lower increase in thickness compared to the other electrolyte compositions.

The electrolytes, battery cells, secondary batteries, and methods of making described herein offer a number of advantages. These advantages include, for example, the use of 2 percent by weight or less of fluoroethylene carbonate. These advantages further include using 10 percent by volume or less of diethyl carbonate. These advantages also include voltage stability at 4.0 volts (V) or greater without increasing gassing. These advantages additionally include temperature stability of 45 degrees Celsius or greater. These advantages further include the formation of a relatively thin and stable solid-electrolyte interface at the anode and cathode electrolyte interface. The advantages also include a relative increase in ionic conductivity with lithium bis(fluorosulfonyl)imide (LiFSI). These advantages yet further include a reduction in lithium plating, especially after formation. These advantages also include reaching maximum or nearly maximum conversion of manganese during formation and simplifies battery management and battery management system programming.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component (s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electrolyte for a battery cell, the electrolyte comprising:
a base electrolyte, wherein the base electrolyte includes a primary lithium salt, a carbonate solvent, and an organic sulfate additive;
lithium bis(fluorosulfonyl)imide (LiFSI) present in the range of 0.1 percent by weight to 1 percent by weight of the total weight of the electrolyte;
a phosphite ester oxygen scavenger present in the range of 0.01 percent by weight to 1.5 percent by weight of the total weight of the electrolyte; and
fluoroethylene carbonate present in the range of 0.5 percent by weight to 2.0 percent by weight of the total weight of the electrolyte,
wherein the base electrolyte is the remaining weight percent of the total weight percent of the electrolyte, and the total weight percent of the electrolyte is 100 percent by weight.

2. The electrolyte of claim 1, wherein the primary lithium salt includes lithium hexafluorophosphate present at a concentration in the range of 0.6 moles of salt per liter (M) to 2.0 M in the carbonate solvent, and the lithium bis(fluorosulfonyl)imide is present at a concentration in the range of 0.01 moles of salt per liter (M) to 0.2 M in the carbonate solvent.

3. The electrolyte of claim 1, wherein the carbonate solvent includes ethylene carbonate, ethyl methyl carbonate, and diethyl carbonate.

4. The electrolyte of claim 3, wherein the ethylene carbonate is present in the range of 20 percent by volume to 30 percent by volume of the total volume of the carbonate solvent, the ethyl methyl carbonate is present in the range of 60 percent by volume to 70 percent by volume of the total volume of the carbonate solvent, and the diethyl carbonate is present in the range of 5 to 10 percent by volume of the total volume of the carbonate solvent, wherein the total volume percent of the carbonate solvent is 100 percent.

5. The electrolyte of claim 1, wherein the organic sulfate additive includes methylene methanedisulfonate and is present in the electrolyte in the range of 0.5 percent by weight to 1 percent by weight of the total weight of the electrolyte.

6. The electrolyte of claim 1, wherein the phosphite ester oxygen scavenger is tris(1,1,1,3,3,3-hexafluoro-2-propyl) phosphite (THFPPi).

7. The electrolyte of claim 1, wherein the base electrolyte includes lithium hexafluorophosphate (LiPF₆) present in the carbonate solvent at a concentration of 1.1 M, ethylene carbonate (EC) present at 25 percent by volume of the total volume of the carbonate solvent, ethyl methyl carbonate (EMC) present at 65 percent by volume of the total volume of the carbonate solvent, diethyl carbonate (DEC) present at 10 percent by volume of the total volume of the carbonate solvent, and the organic sulfate additive is methylene methanedisulfonate present at 1 percent by weight of the total weight of the electrolyte and wherein the lithium bis(fluorosulfonyl)imide (LiFSI) is present at 0.1 percent by weight of the total weight of the electrolyte, the phosphite ester oxygen scavenger is tris(1,1,1,3,3,3-hexafluoro-2-propyl) phosphite present at 0.05 precent by weight of the total weight of the electrolyte, and fluoroethylene carbonate (FEC) is present at 1 percent by weight of the total weight of the electrolyte.

8. A battery cell for a vehicle, comprising:
a cathode electrode including a cathode disposed on a cathode current collector;
an anode electrode including an anode disposed on an anode current collector;
a separator positioned between the cathode and the anode; and
an electrolyte contacting the cathode, anode, and separator, wherein the electrolyte includes:
a base electrolyte, wherein the base electrolyte includes a primary lithium salt, a carbonate solvent, and an organic sulfate additive;
lithium bis(fluorosulfonyl)imide (LiFSI) present in an amount in the range of 0.1 percent by weight to 1 percent by weight of the total weight of the electrolyte;
a phosphite ester oxygen scavenger present in the range of 0.01 weight percent to 1.5 weight percent of the total weight of the electrolyte; and
fluoroethylene carbonate present in the range of 0.5 percent by weight to 2.0 percent by weight of the total weight of the electrolyte,
wherein the base electrolyte is the remaining weight percent of the total weight percent of the electrolyte, and the total weight percent of the electrolyte is 100 percent by weight.

9. The battery cell of claim 8 wherein the primary lithium salt includes lithium hexafluorophosphate present at a concentration in the range of 0.6 M to 2.0 M in the carbonate solvent, and the lithium bis(fluorosulfonyl)imide is present at a concentration in the range of 0.01 M to 0.2 M in the carbonate solvent.

10. The battery cell of claim 8, wherein the carbonate solvent includes ethylene carbonate, ethyl methyl carbonate, and diethyl carbonate.

11. The battery cell of claim 10, wherein the ethylene carbonate is present in the range of 20 percent by volume to 30 percent by volume of the total volume of the carbonate solvent, the ethyl methyl carbonate is present in the range of 60 percent by volume to 70 percent by volume of the total volume of the carbonate solvent, and the diethyl carbonate is present in the range of 5 to 15 percent by volume of the total volume of the carbonate solvent, wherein the total volume percent of the carbonate solvent is 100 percent.

12. The battery cell of claim 8, wherein the organic sulfate additive is methylene methanedisulfonate, wherein the methylene methanedisulfonate is present in the electrolyte in the range of 0.5 percent by weight to 1 percent by weight of the total weight of the electrolyte.

13. The battery cell of claim 8, wherein the primary lithium salt includes lithium hexafluorophosphate present at a concentration in the range of 0.6 M to 2.0 M in the carbonate solvent, the carbonate solvent includes ethylene carbonate present in the range of 20 percent by volume to 30 percent by volume of the total volume of the carbonate solvent, ethyl methyl carbonate present in the range of 60 percent by volume to 70 percent by volume of the total volume of the carbonate solvent, and diethyl carbonate present in the range of 5 to 10 percent by volume of the total volume of the carbonate solvent, wherein the total volume percent of the carbonate solvent is 100 percent, and the organic sulfate additive is methylene methanedisulfonate present in the electrolyte in the range of 0.5 percent by weight to 1 percent by weight of the total weight of the electrolyte.

14. The battery cell of claim 8, wherein the phosphite ester oxygen scavenger is tris(1,1,1,3,3,3-hexafluoro-2-propyl) phosphite (THFPPi).

15. The battery cell of claim 8, wherein the cathode exhibits the following composition: xLi₂MnO₃-(1-x)LiMO₂, where “M” is at least one of nickel, cobalt, and manganese, and “x” is in the range of 0 to 1.

16. The battery cell of claim 8, wherein the cathode is selected from at least one of lithium nickel manganese oxides, lithium nickel manganese cobalt oxides, lithium nickel cobalt aluminum oxides, and lithium nickel cobalt manganese aluminum oxide.

17. The battery cell of claim 8, wherein the anode includes at least one of graphite and graphite-silicon, wherein silicon is present in the range of 0.1 percent by weight to 30 percent by weight of the total weight of the graphite-silicon.

18. A method of forming an electrolyte, comprising: mixing a base electrolyte, wherein the base electrolyte includes a primary lithium salt, a carbonate solvent, and an organic sulfate additive, with lithium bis(fluorosulfonyl)imide (LiFSI) present in an amount in the range of 0.1 percent by weight to 1 percent by weight of the total weight of the electrolyte, a phosphite ester oxygen scavenger present in the range of 0.01 percent by weight to 1.5 percent by weight of the total weight of the electrolyte, and fluoroethylene carbonate present in the range of 0.5 percent by weight to 2.0 percent by weight of the total weight of the electrolyte, wherein the base electrolyte is the remaining weight percent of the total weight percent of the electrolyte and the total weight percent of the electrolyte is 100 percent by weight.

19. The method of claim 18, further comprising forming the base electrolyte by mixing the primary lithium salt, the carbonate solvent, and the organic sulfate additive, wherein the primary lithium salt includes lithium hexafluorophosphate present at a concentration in the range of 0.6 M to 2.0 M in the carbonate solvent, the carbonate solvent includes ethylene carbonate present in the range of 20 percent by volume to 30 percent by volume of the total volume of the carbonate solvent, ethyl methyl carbonate present in the range of 60 percent by volume to 70 percent by volume of the total volume of the carbonate solvent, and diethyl carbonate present in the range of 5 to 10 percent by volume of the total volume of the carbonate solvent, wherein the total volume percent of the carbonate solvent is 100 percent, and the organic sulfate additive is methylene methanedisulfonate present in the electrolyte in the range of 0.5 percent by weight to 1 percent by weight of the total weight of the electrolyte.

20. The method of claim 18, further comprising introducing the electrolyte into a battery cell; charging and discharging the battery cell at temperatures in the range of 45 degrees Celsius to 80 degrees Celsius; and forming a solid-electrolyte interface.
